(19) United States
(12) Patent Application Publication
(10) Pub. No.: US 2024/0265482 A1
(43) Pub. Date: Aug. 8, 2024

(54) Educational Harassment Application

(71) Applicant: Targets' Tip, Okemos, MI (US)

(72) Inventor: Morteza Mahmoudi, Okemos, MI (US)

(73) Assignee: Targets' Tip, Okemos, MI (US)

(21) Appl. No.: 18/417,423

(22) Filed: Jan. 19, 2024

Related U.S. Application Data
(60) Provisional application No. 63/482,804, filed on Feb. 2, 2023.

(51) Int. Cl. G06Q 50/20

(52) U.S. Cl. CPC G06Q 50/205

(57) ABSTRACT

A portable electronic device is programmed to perform a method for assessing educational, or other, harassment, including, at least, including determining whether educational harassment has occurred. If educational harassment has occurred, connect a target of the educational harassment with a connection, such as an advisor. The method includes (i) storing data on types of educational harassment reported through an application and assessing the stored data, including storing data in discipline specific categories, (ii) determining whether the target has accepted the advisor, if the target has accepted the advisor, and (iii) connecting the target and the advisor through a chat system. The method may also include creating tailored educational programs based on the educational harassment reported through the application for delivery to specific institutions experiencing that educational harassment.

### CROSS-REFERENCE TO RELATED APPLICATIONS

This application claims the benefit of U.S. Provisional Application No. 63/482,804, filed 2 Feb. 2023, which is hereby incorporated by reference in its entirety.

### INTRODUCTION

This disclosure generally relates to applications, or apps, used to assess, generate data, and respond to educational and research harassment.

### SUMMARY

A portable electronic device, method, and non-transitory computer-readable storage medium on which is recorded instructions is provided. Execution of the instructions by a processor causes the processor to determine whether educational harassment has occurred; if educational harassment has occurred, connect a target of the educational harassment with a connection, including an advisor; store data on the types of educational harassment reported through the application; and assess the stored data.

The non-transitory computer-readable storage medium may also collect data in a discipline specific manner. Automated systems utilizing the data storage medium may determine whether the target has accepted the advisor, and if the target has accepted the advisor, connect the target and the advisor through a chat system.

The systems may also create tailored educational programs based on the educational harassment reported through the application for delivery to specific institutions experiencing that educational harassment. The systems may report the data to one or more institutions.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIG. 1 schematically illustrates a method, process, or flow chart for assessing and/or reporting academic harassment.

FIGS. 2A and 2B schematically illustrate screen shots of an app for identifying and tracking educational and research harassment, with FIG. 2A showing a login screen and FIG. 2B showing a target screen.

FIG. 3 schematically illustrates a screen shot of a heat map showing educational harassment reports at various institutions.

FIG. 4 schematically illustrates a screen shot of a conversation between a target and an advisor or connection.

FIG. 5 schematically illustrates some of the systems that may be used with the app for assessing and/or reporting academic harassment.

FIGS. 6A and 6B schematically illustrate screen shots of an app for identifying and tracking educational harassment, with FIG. 6A showing an ethnicity selection screen and FIG. 6B showing a discipline selection screen.

### DETAILED DESCRIPTION

Academic harassment is a serious, yet unresolved, issue that affects both targets (e.g., college students, postdocs, and faculty of various ranks), the people around them, and the scientific community. Academic harassment can cause complex mental and physical disorders, including, without limitation, post-traumatic stress disorder (PTSD) and severe cardiovascular disease. The application, or app, described herein app looks to capture data on behavior regarding academic harassment of professors, administrators, graduates, and other students at universities.

The prevalence of academic harassment is greater than 30% in, at least, the United States. The poor response to academic harassment by institutional entities and stakeholders (e.g., funding agencies and academic gatekeepers) is largely due to the lack of robust and comprehensive data in harassment types and their contextual behaviors. Surveys found that less than 2% of targets harassed in academia report it, mainly due to the fear of retaliation, job loss, visa cancellation, and/or mobbing (ganging-up against targets) behaviors.

Referring to the drawings, like reference numbers correspond to like or similar components wherever possible throughout the several figures. All figures may be referred to in any section of the specification, without regard to numerical order.

The behaviors discussed herein are not limiting, as other harassment behaviors may exist that are not, specifically, addressed, as will be recognized by those having ordinary skill in the art. Alternative applications that encourage targets to report harassment are typically run by institutional administration, and they require targets to disclose their identity, meaning targets feel less secure and are less likely to use the apps to seek help. The application may be accessed through an app icon on, for example and without limitation, a smart device.

As used herein, “targets” refers to anyone subjected to academic, or other, harassment. As used herein, “educational harassment” includes any type of harassment, including, without limitation, research institutions and/or businesses. Skilled artisans will recognize the different types of educational harassment, in addition to those listed herein or shown in the figures. Some examples, without limitation, of education harassment, include: abuse of credit, abuse of rules, incorrect authorship, coercive controls, metal abuse threats/actions, mobbing actions, physical threats/actions, retaliation, sexual abuse threats/actions, verbal abuse threats/actions, or combinations thereof.

While the present disclosure may be illustrated with respect to particular industries or applications, those skilled in the art will recognize the broader applicability of the products, methods, and techniques described herein. For example, similar structures, methods, or combinations thereof, may be used in other industries or for other procedures/processes than those described herein. The order of any method or process steps described herein is not limiting.

Those having ordinary skill in the art will also recognize that terms such as “above,” “below,” “upward,” “downward,” et cetera, are used descriptively of the figures, and do not represent limitations on the scope of the appended claims. Any numerical designations, such as “first” or “second” are illustrative only and are not intended to limit the scope of the claims in any way.

When used herein, the term “substantially” refers to relationships that are ideally perfect or complete, but where manufacturing realties prevent absolute perfection. Therefore, substantially denotes typical variance from perfection in the relevant art. For example, if height A is substantially equal to height B, it may be preferred that the two heights are 100.0% equivalent, but manufacturing realities likely result in the distances varying from such perfection. Skilled artisans would recognize the amount of acceptable variance. For example, and without limitation, coverages, areas, or distances may generally be within 10% of perfection for substantial equivalence. Similarly, relative alignments, such as parallel or perpendicular, may generally be within 5%.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting.

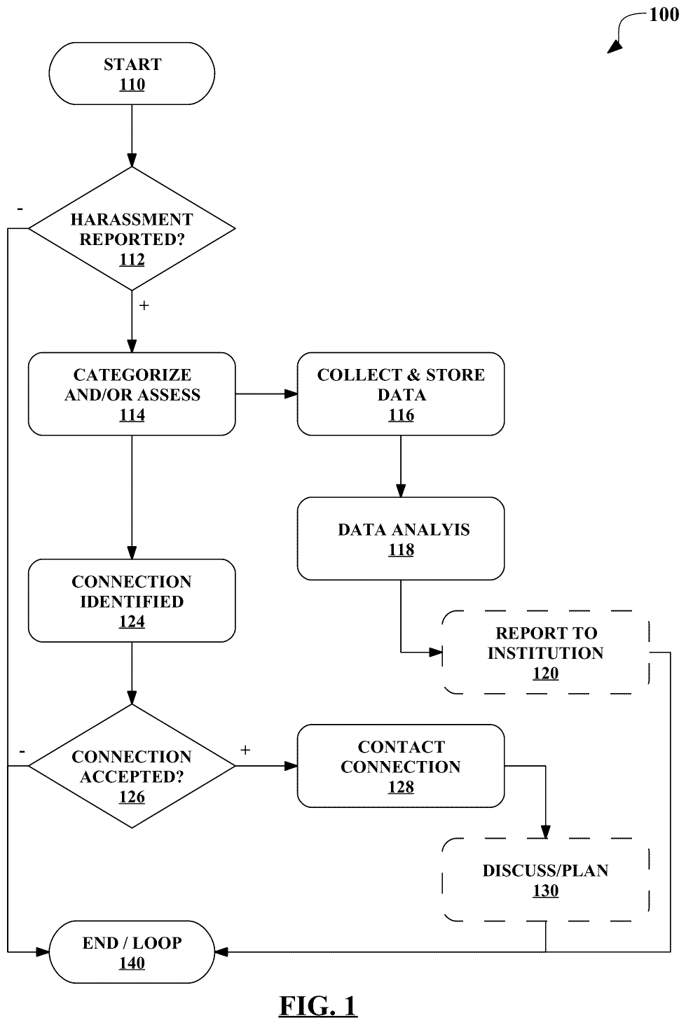

As shown in FIG. 1 there is a process, flow chart, or method 100 illustrating some of the possible processes for identifying and creating data related to educational harassment. Note that steps identified as optional are explicitly optional. However, other steps may be optional, as will be recognized by those having ordinary skill in the art. Additionally, any steps illustrated may be reordered, skipped, or dropped.

### STEP 110: START

The method 100 starts at step 110, which may be in response to a trigger or to the app turning on. Note that the methods described herein may be looping iteratively and/or constantly looking for trigger events to begin any of the processes described herein.

The application or app is user friendly and heavily secured because it deals with user data. Importantly, the app is multiplatform to give as many users as possible the ability to interact with the software. Portable electronic devices may be used herein to characterize the device, or devices, running or displaying the app. This may include, without limitation, smart phones, tablets, laptops, or fixed devices.

### STEP 112: HARASSMENT REPORTED?

At step 112, the method 100 determines whether harassment has been reported. This generally, but without limitation, occurs via user interaction with the application or app, often by a target of harassment. If no harassment is reported, the method 100 ends or loops, but if harassment has been reported, such as via the app, the method 100 continues.

A generalized control system, computing system, or controller is operatively in communication with relevant components of, at least, the systems described herein. The controller includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or communication protocols. One or more of the methods described herein may be executed by the controller, including the non-transitory computer-readable storage medium, or other structures or equipment recognizable to skilled artisans.

Furthermore, the controller may include, or be in communication with, a plurality of sensors, including multiple cameras. The controller is configured to execute or implement all control logic or instructions described herein and may be communicating with any sensors described herein or recognizable by skilled artisans.

The controller may be dedicated to the specific aspects of the systems described herein or may be part of a larger control system that manages numerous other functions.

The generalized control system may execute artificial intelligence (AI) via any methods or techniques recognizable to those having ordinary skill in the art. Note that the control system may be using one or more servers and/or cloud servers for operation.

### STEP 114: CATEGORIZE AND/OR ASSESS

Below is a list, without limitation, of the contextual behaviors that may be categorized and/or assessed into possible groupings. Skilled artisans will recognize other behaviors that may be selected.

Abuse of credit—i.e., using one's data without acknowledging contribution, unfair credit distribution on works, manuscripts, and intellectual properties. Abuse of rules, regulations, and ethical guidelines—e.g., invading privacies, forcing to manipulate or cherry pick data and forcing to sign away authorship and/or intellectual property rights. Additionally, authorship conflicts may exist.

Coercive controls—i.e., isolation, monitoring activity, restricting autonomy, lengthening lab hours, gaslighting, and/or silent treatment. Mental harassment—e.g., telling someone they are incompetent and/or that their thoughts or feelings are stupid. Mobbing actions, including ganging up against someone. Physical and/or sexual harassment. Retaliation—such as giving unfairly bad recommendations, running careers, and interfering in job offers. Threats, including canceling positions, visas, and/or funding. Verbal abuse—e.g., blaming, lying, yelling, cursing, name-calling, and/or sarcasm.

### STEP 116: COLLECT AND STORE DATA

The data is stored for later analysis. The app may also collect data in a discipline specific manner, including, without limitation, categories: physics, chemistry, or medicine.

### STEP 118: DATA ANALYSIS

The app generates data on the frequency, types, and contextual behaviors of academic harassment in discipline specific categories and manner for one or more institutions who need them to improve the overall academic organizational health. Technological innovation is that, unlike other apps, this app is global and therefore the targets feel more secure to seek help mainly because: one, the app is not run by institutional administration; two, the app does not require identity of the target.

The app not only helps targets to consider their options and minimize the mental side effects of such behaviors, but also creates the required global data on the frequency of incidences of academic harassment with specific types and contextual behaviors.

The admin portal/app would be separate allowing administrative users to look at organized data from a database and manage users on the main platform. This administrator portal is less likely to be multiplatform, but it would need to be just as easy to use and just as secure as the primary app software.

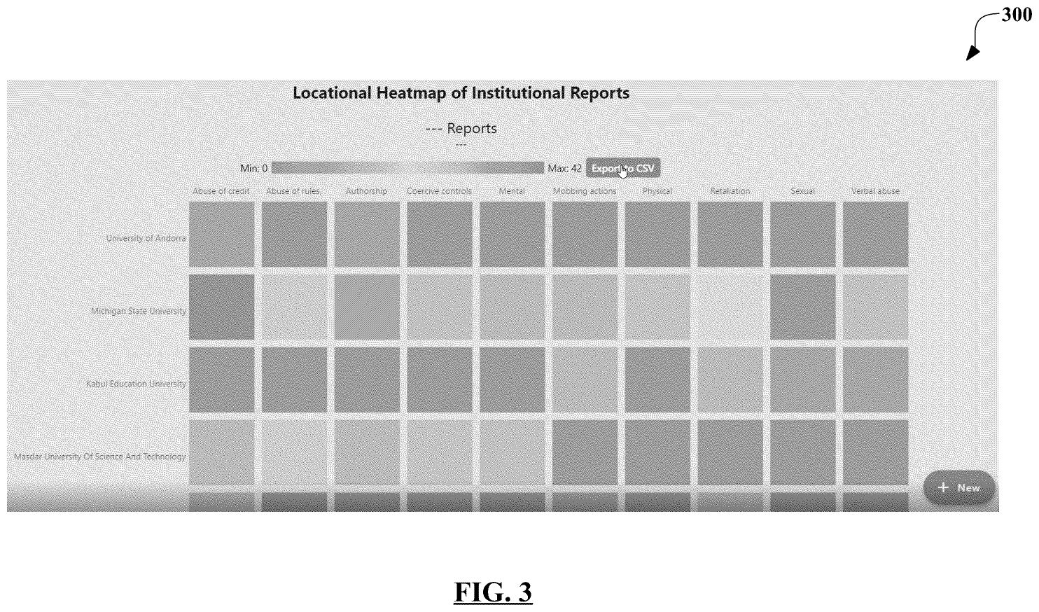

FIG. 3 illustrates a heat map 300 schematically illustrating different areas of harassment at different institutions. This may be one of the ways the collected and analyzed data is used, which helps visually display areas of need for one or more institutions. Skilled artisans will recognize other behaviors that may be listed.

The heat map may be used with data transformations and may further be used to create discipline specific educational programs to bolster education for various institutions. Note that the heat map may be displayed on one or more devices not associated with the portable electronic device, such as a fixed computer or a display associated with a cloud or server.

### STEP 120: REPORT TO INSTITUTION (OPTIONAL)

The data may or may not, be reported to one or more institutions about which it is collected. Importantly, institutions may use this data to address issues, including, without limitation, training of administration, faculty, and/or students. In this case, institutions can get robust data on the frequency of academic harassment in a discipline specific manner combined with discipline specific educational packages to improve their organizational health.

As an additional, optional, step, the data may be used to develop discipline specific educational videos. This may be part of step 120 reporting to the institution or in a separate step. Using the data on the types and contextual behaviors of academic harassment in their departments or scientific disciplines, we enable institutions to better monitor and, also, provide discipline specific educational videos to the departments which have significant incidences of academic harassment.

### STEP 124: CONNECTION/SUPPORTER IDENTIFIED

Users on the platform can sign up for an account and select which specific types and contextual behaviors of harassment with which they are struggling.

Additionally, users may also sign up as connections or supporters and note the types and contextual behaviors of harassment for which they are able to provide support.

The app may also connect to supporters including survivors, lawyers, and counselors (e.g., trauma experts) to assist the targets of harassment. Based on the user's selections and an advisor's rating, the platform proposes potential matches—based on specific scientific disciplines and institutional culture and/or location—be that a target for an advisor or an advisor for a target. Furthermore, note that more than one connection may be provided by the app or method 100, such that several advisors, counselors, survivors may be suggested.

Note that an administrative portal may be used to verify the lawyers, counselors, and/or advisors. The administrators may verify, without limitation, credentials and/or certifications. In some situations, the administrative portal may be used to remove the connections, such as where it is determined that improper information was entered.

### STEP 126: CONNECTION ACCEPTED?

The user may or may not want to accept the connection for support. Note that the user may be either a target or a connection. At step 126, the method 100 determines whether the user has accepted the supporter connection from the app. If the connection is not accepted, the method 100 ends or loops.

However, if the connection is accepted, the method 100 continues to step 128. Note that if a support connection declines the connection, method 100 may loop back to step 124 to identify a different connection, particularly if no other connections were provided.

### STEP 128: CONTACT CONNECTION

The user is then able to request to connect with one, or more, of their matches, and upon approval from the match, can chat online. The chat windows within the app were substantially designed to mimic a messaging app, such that targets, survivors, and supporters are familiar with the interface views. FIG. 4 schematically illustrates a screen shot of a conversation 400.

Upon conclusion of a conversation, the target is asked to rate their advisor, which gets factored into the rating of their advisor to help future targets pick their match. These ratings are stored in a database or cloud database. Note that the advisors may have discussions with the target or form a plan with the target.

### STEP 130: DISCUSS AND/OR PLAN (OPTIONAL)

The contact or supporter and the user—likely a target—may discuss or plan strategies for responding to academic harassment. Depending on the harassment situation, that may include, without limitation, legal action, counseling, or filing a complaint with the institution. Based on the academic research findings, the application is working on developing an app to create a safe place for targets of academic harassment to get support from experts in specific contextual harassment behavior.

### STEP 140: END/LOOP

At step 140, the method 100 ends or loops. The method 100 may be constantly running or may be looping iteratively.

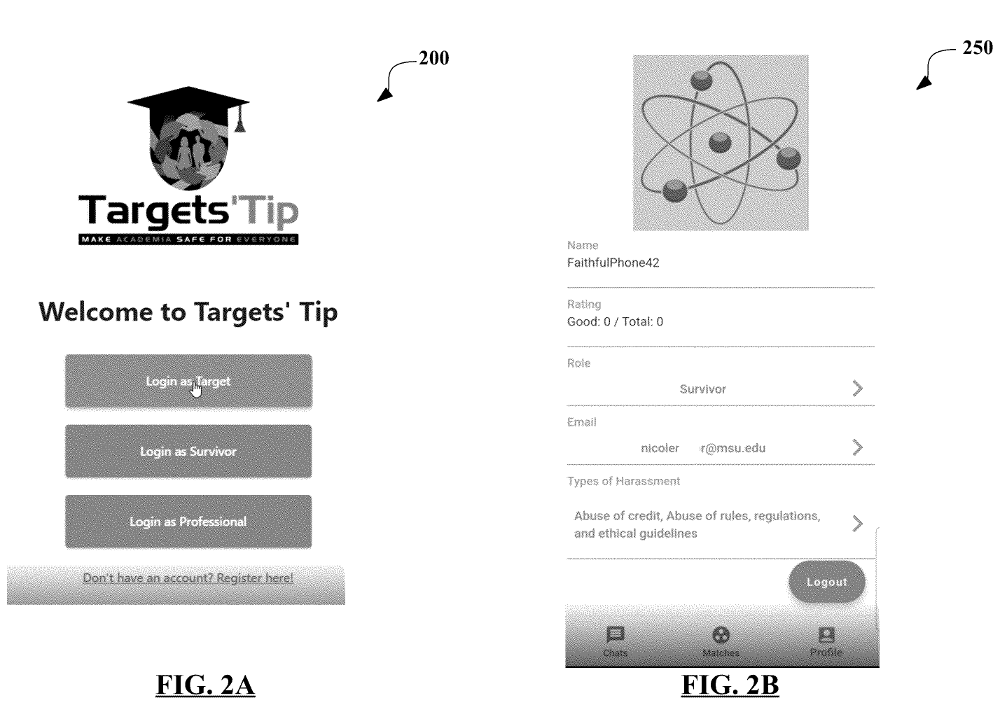

FIGS. 2A through 6B show exemplary views from different applications utilizing the techniques and tools described herein. These, largely, screen shots are illustrative, and are not limiting, of some of the applications for the methods described herein. Some of these have already been discussed relative to method 100.

FIGS. 2A and 2B schematically illustrate screen shots of an app for identifying and tracking educational harassment, with FIG. 2A showing a login screen 200 and FIG. 2B showing a target screen 250. Note that the registration process may include password strength requirements, such that the users secure their accounts.

FIG. 4 shows an exemplary conversation between a recommended connection, skilled artisans may recognize other conversations that may occur between the target and connection.

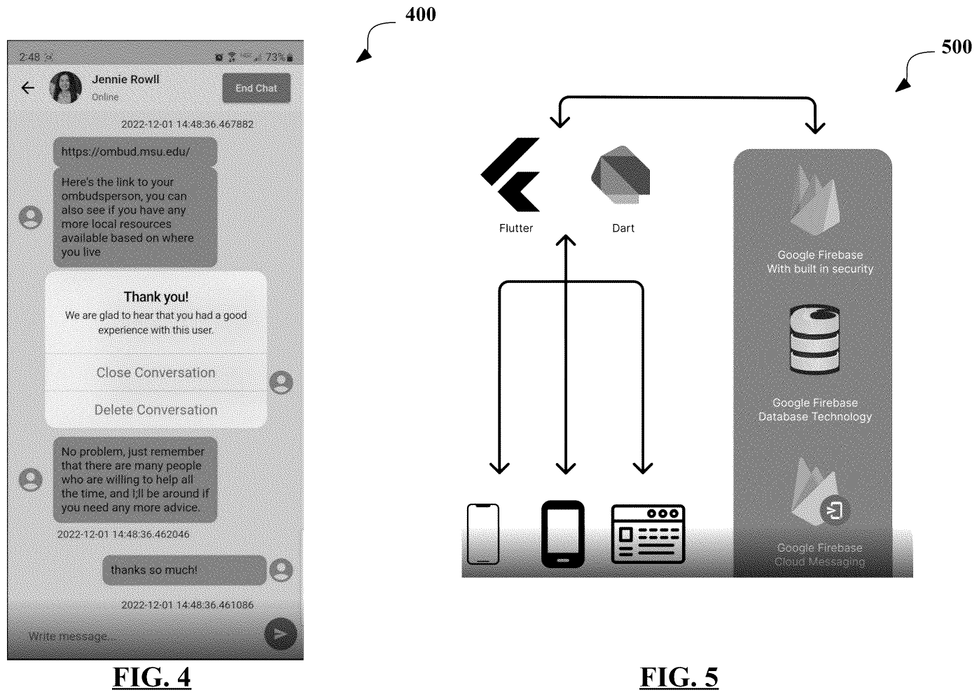

FIG. 5 schematically illustrates some systems 500 that may be used with the app for assessing and/or reporting academic harassment. Note that this figure, and all descriptions, are only one example of possible system architecture, or architectures, as will be recognized by those having ordinary skill in the art.

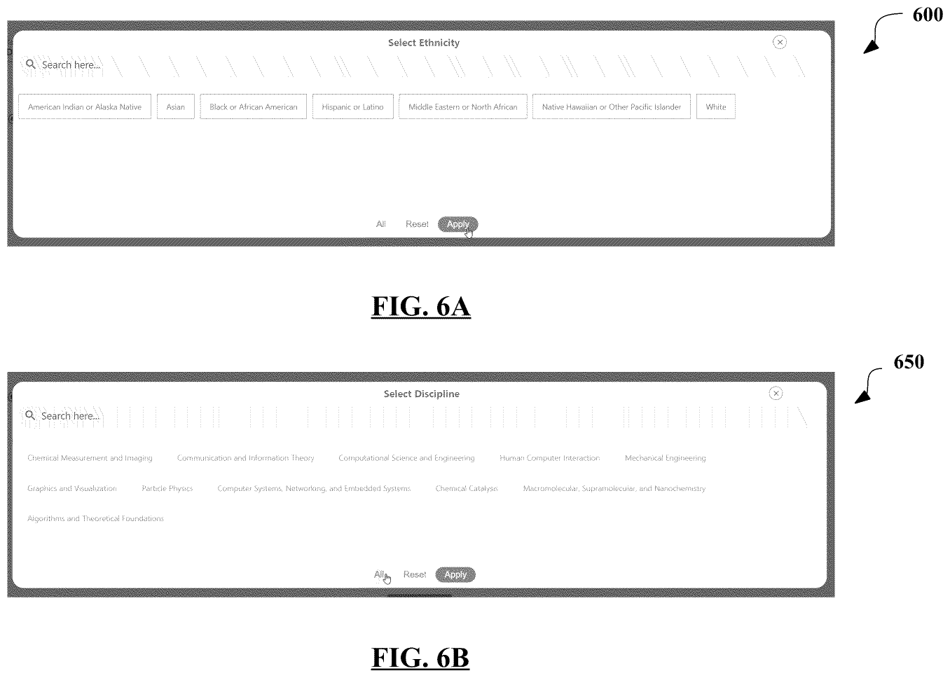

FIGS. 6A and 6B show exemplary ethnicities and disciplines. Skilled artisans may recognize other disciplines and ethnicities that may be displayed.

An open-source development kit, Flutter, was used. Since the software was created to be multiplatform, this allowed development to cut back both on time and possible issues caused by creating apps using native codes and possibly having to port code from one device to another. Flutter uses a language called Dart, which when run, can compile native source code for the multiplatform devices, while substantially simultaneously making HTML, cascading style sheets (CSS), and JavaScript files for the web version. Note that skilled artisans may recognize other development kits that may be used for multiplatform software.

The application and methods might have been difficult to implement if it was unable to communicate with an external server. To link the database to our applications, we used several packages to streamline authentication and provide easier utility to access the database and send information to and from the database. One exemplary database, without limitation, is Google Firebase. These packages include a core for base level functions to interact with firebase, authentication of users on the software and allow logins, cloud services to receive or set data in collections as well as to manage messaging, and storage to save user documents.

The database in Firebase is structured to have seven collections, without limitation: Conversations, User Flags, Heatmaps, Messages, Ratings, Reports, and Statuses. Conversations hold collections that have the user as well as other users that they have matched with as fields. Flags holds the harassment types that a user is currently experiencing or could possibly assist with. Heatmap shows the data present in the heatmaps as well as the selected universities for each data row.

Messages has a collection of exchanges between two users, each collection holds documents which are the individual messages sent between the two. Each message has fields for the content, who it is from and who it is to, a timestamp, as well as the message type. Ratings has users who have any ratings, and the fields are the number of good ratings and the total ratings.

Reports keep track of any reports sent to the admin about a specific user. The fields being the user made report and the user it applies to. Finally, Status holds the details of the users, such as their role, verification status, discipline, display name, email, ethnicity, institution, username, and time that the account was created. If the account is not a target, it also has a profile image URL and description. Professionals also have a field for a document URL.

Another part of Google Firebase is file storage. Here, there are three folders to hold various pieces of user data. The assets folder holds the static images used in the main app and hosts them online. Certifications holds professional documents for review and only accepts PDF files provided during sign-up. The final folder is for profile photos that professionals provide during sign-up. These pieces of saved data can only be read or written by users authenticated by Firebase in the main or administrator applications. Skilled artisans will recognize alternative cloud-based, or internal servers, storage systems for dealing with storage.

FIGS. 6A and 6B schematically illustrate screen shots of an app for identifying and tracking educational harassment, with FIG. 6A showing an ethnicity selection screen 600 and FIG. 6B showing a discipline selection screen 650. The ethnicity selection screen 600 may assist in both classification of users and selecting connections between targets and advisors. The discipline selection screen 650 may assist in matching targets and advisors/counselors.

The forgoing solutions improve upon the current state of the art of harassment reporting systems by connecting targets with counselors and generating/assessing data that can be used by various institutions. The discipline specific educational programs generated from this data are also an improvement over the current state of the art.

The detailed description and the drawings or figures are supportive and descriptive of the disclosure. Note that the drawings may not be to scale. While some of the best modes and other embodiments for carrying out the disclosure have been described in detail, various alternative designs, configurations, and embodiments exist for practicing the appended claims, as will be recognized by those having ordinary skill in the art.

1. A portable electronic device, comprising:
a screen configured to display an app icon; and
a processor that executes an application for assessing educational harassment, to thereby:
determine whether educational harassment has occurred; and
if educational harassment has occurred, connecting a target of the educational harassment with an advisor.

2. The portable electronic device for assessing educational harassment of claim 1, further comprising:
store data on types of educational harassment reported through the application.

3. The portable electronic device for assessing educational harassment of claim 2, further comprising:
assess the stored data.

4. The portable electronic device for assessing educational harassment of claim 3, wherein storing data on the types of educational harassment includes data on discipline specific categories.

5. The portable electronic device for assessing educational harassment of claim 4, wherein the stored data is on one or more clouds.

6. A non-transitory computer-readable storage medium on which is recorded instructions, wherein execution of the recorded instructions by a processor causes the processor to:
determine whether educational harassment has occurred;
if educational harassment has occurred, connect a target of the educational harassment with a connection, including one or more advisors;
store data on types of educational harassment reported through an application; and
assess the stored data.

7. The non-transitory computer-readable storage medium of claim 6, wherein execution of the recorded instructions by the processor causes the processor to:
determine whether the target has accepted the advisor; and
if the target has accepted the advisor, connect the target and the advisor through a chat system.

8. The non-transitory computer-readable storage medium of claim 7, wherein execution of the recorded instructions by a processor causes the processor to:
create tailored educational programs based on the educational harassment reported through the application for delivery to specific institutions experiencing that educational harassment.

9. The non-transitory computer-readable storage medium of claim 8, wherein execution of the recorded instructions by a processor causes the processor to:
report relevant data to one or more institutions.

10. The non-transitory computer-readable storage medium of claim 9, wherein execution of the recorded instructions by a processor causes the processor to:
discuss or form a plan with the one or more advisors.

11. A method for assessing educational harassment, comprising:
determining whether educational harassment has occurred;
if educational harassment has occurred, connecting a target of the educational harassment with a connection, including one or more advisor;
storing data on types of educational harassment reported through an application;
determining whether the target has accepted the advisor;
if the target has accepted the advisor, connecting the target and the advisor through a chat system; and
creating tailored educational programs based on the educational harassment reported through the application for delivery to specific institutions experiencing that educational harassment.

12. The method for assessing educational harassment of claim 11, further comprising:
assessing the stored data.

13. The method for assessing educational harassment of claim 12, further comprising:
generating a heat map based on the stored data on the types of educational harassment at various institutions.

14. The method for assessing educational harassment of claim 13, further comprising:
discussing or forming a plan with the advisor.

15. The method for assessing educational harassment of claim 14, further comprising:
reporting relevant data to one or more institutions.
